(19) United States
(12) Patent Application Publication
(10) Pub. No.: US 2006/0172765 A1
(43) Pub. Date: Aug. 3, 2006

(54) Gel filled mobile phone case

(76) Inventor: Yosef Lev, Baltimore, MD (US)

Correspondence Address: OBER/KALER;c/o Royal W. Craig, 120 East Baltimore Street, Baltimore, MD, 21202, US

(21) Appl. No.: 11/337,926

(22) Filed: Jan. 24, 2006

Related U.S. Application Data
(60) Provisional application No. 60/647,946, filed on Jan. 29, 2005.

(51) Int. Cl. H04M 1/00

(52) U.S. Cl. 455/550.1

(57) ABSTRACT

A decorative carrying case for mobile telephones, personal digital assistants (PDAs), cameras, and other portable electronic devices that incorporates outwardly-visible reservoirs of cohesive gel therein for a striking aesthetic effect, with or without discrete ornaments that float in the gel to pronounce the effect. The gel reservoirs also provide padding and insulation to protect the mobile phone while providing a useful and unique aesthetic structure.

### CROSS REFERENCE TO RELATED APPLICATIONS

The present application derives priority from U.S. Provisional Patent Application 60/647,946 for “GEL-FILLED MOBILE PHONE CASE”, filed Jan. 28, 2005.

### BACKGROUND OF THE INVENTION

1. Field of the Invention

The present invention relates to carrying cases for mobile telephones, personal digital assistants (PDAs) and other personal electronics, and more particularly, to an improved mobile telephone case that includes visual reservoirs of colored gel therein, with or without suspended ornaments, that provides a striking decorative appearance and further provides padding and insulation to protect the mobile phone.

2. Description of the Background

Mobile telephones have become commonplace in recent years. Indeed, some individuals use their mobile telephones more frequently than their land line telephone. Most mobile telephone owners carry their respective mobile telephone with them wherever they go, at work, play and even at home. Like many other utilitarian devices, cell phones have become a fashion statement: a reflection of the user's personality. This is exemplified by the vast array of available colors, styles, feature options, ring tones, and accessories that can be purchased. One accessory in particular determines how the owner wears their cell phone, and what it looks like as they are wearing—the cell phone case. Originally developed as non-descript protective covers because cell phones can easily be damaged, cell phone cases now come in a myriad of colors and styles. Many are quite innovative in some respect, either in their protective abilities or aesthetics.

For example, U.S. Pat. No. 6,082,535 to Mitchell discloses a protective covering for a cell phone or pager comprising a one piece resilient water-impermeable bag. The bag has a single opening, through which the phone is inserted with a layer of adhesive around the opening. In the closed position, the adhesive layer forms a water impermeable seal for the opening of the bag.

U.S Pat. No. 6,754,344 to Kohli et al. discloses a case for a folding-type mobile phone with two separate sections, one for the body of the phone and one for the cover. Each section has elastic portions and the sections snap together so that the case can fit various models sizes.

U.S. Pat. No. 6,568,576 to Godshaw, et al. discloses a cell phone pouch comprising an elongate strap with a pocket having elastic sides on one side of the strap. The pocket is open at both ends and the strap may be exte3neded through the pocket to accommodate phones of various sizes. U.S. Pat. No. 6,454,146 to Alis discloses a cell phone holder comprising a fixed, substantially horizontal phone pocket with open end.

Generally, mobile telephone cases, covers and holders are sewn or molded of material such as plastic, or flexible material such as leather or fabric, with or without padding to protect the mobile phone. However, the prior art is void of any mobile phone case, holder or cover that accentuates the padding, turning it into a distinguishing ornamental feature, while still providing a strong cushion to protect the phone from damage. Gel-filled reservoirs are also known to provide good padding in the prior art. There are gel-filled eye masks, gel-filled cushions and pillows, gel-filled mouse pad, etc. Most of these gel-filled objects rely on the gel for cushion, not for their aesthetic value. The prior art does not teach how gel-filled reservoirs can be made aesthetically unique and pleasing, let alone how to incorporate them in the structure of mobile telephone cases or holders.

### SUMMARY OF THE INVENTION

Accordingly, it is the aim of the present invention to provide a mobile telephone case that includes visual reservoirs of colored gel, with or without suspended ornaments, that provides a striking decorative appearance and further provides padding and insulation to protect the mobile phone.

It is a further object of the invention to provide a gel-containing mobile telephone case that is lightweight and easy to use.

It is a still further object of the invention to provide a gel-containing mobile telephone case that comes in various designs and colors.

It is yet another object of the invention to provide a gel-containing mobile telephone case that incorporates discrete reservoirs of cohesive gel.

It is yet another object of the invention to provide a gel-containing mobile telephone case that incorporates suspended ornaments floating in the gel.

It is a still further object of the invention to provide a gel-containing mobile telephone case that is economical to manufacture.

The above objects are accomplished by providing an improved, attention-grabbing mobile telephone case design that additionally cushions and insulates the mobile phone to protect it from being dropped or bumped, etc. The mobile telephone case includes visual reservoirs of cohesive gel that may include an array of discrete ornaments floating therein. The gel may be colorless, but is preferably brightly colored and fluorescent. In addition to aesthetics, the gel-containing reservoirs provide padding and insulation to protect the mobile phone, while providing a useful and unique aesthetic structure. The effect of the gel and floating ornaments is visible through the clear plastic surrounding the reservoir, and this creates a unique aesthetic visual impression.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a rear perspective view of the gel-containing mobile telephone case, exclusive of the mobile phone, in the open position.

FIG. 2 is a front perspective view of the gel-containing mobile telephone case, exclusive of a mobile phone, in the open position.

FIG. 3 is a rear perspective view of the gel-containing mobile telephone case, inclusive of the mobile phone, in the open position.

FIG. 4 is a front perspective view of the gel-containing mobile telephone case, inclusive of a mobile phone, in the open position.

FIG. 5 is a left side perspective view of the gel-containing mobile telephone case, mobile phone shown in dotted lines, in the open position.

FIG. 6 is a right side perspective view of the gel-containing mobile telephone case, mobile phone shown in dotted lines, in the open position.

FIG. 7 is a rear perspective view of exemplary floating ornaments of FIG. 1 and belt clip.

### DETAILED DESCRIPTION OF THE PREFERRED EMBODIMENTS

The present invention is a carrying case for mobile telephones, personal digital assistants (PDAs) and other personal electronics, that includes visual reservoirs of cohesive gel with or without discrete ornaments floating therein. The gel may be colorless, but is preferably brightly colored and the color may be fluorescent for maximum effect. The gel-filled reservoirs are encased in clear plastic or plastic-like material such that the gel and its floating contents are easily viewed. The gel provides a striking aesthetic and, in addition, padding and insulation in a compact form to protect the mobile phone or other electronics.

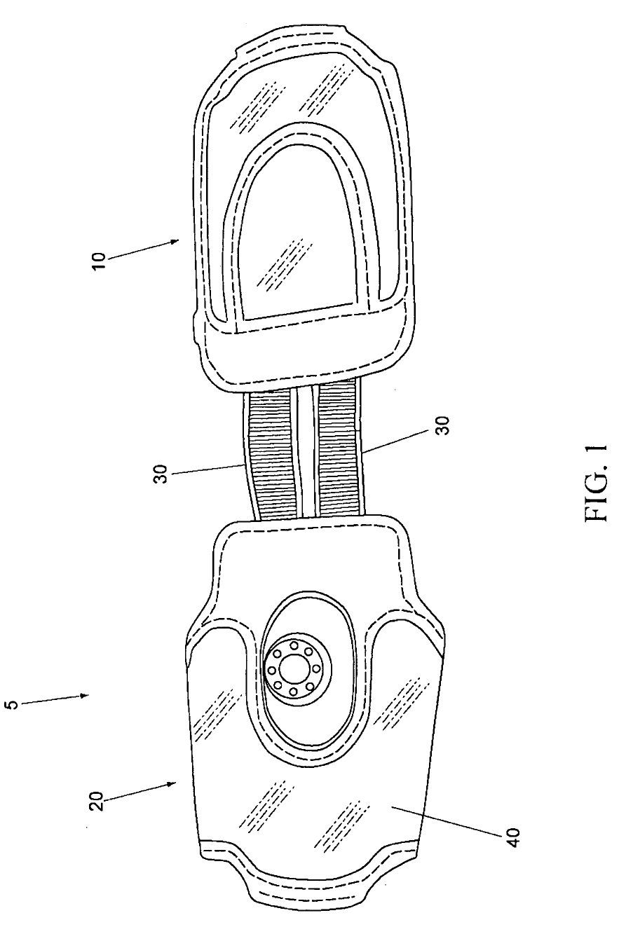

FIGS. 1 through 7 show various views of a preferred embodiment of the gel-containing carrying case specifically adapted for mobile telephones. The embodiment shown in FIGS. 1 through 7 is intended for a standard flip-phone. However, one skilled in the art will understand that the gel-containing case of the present invention can be made in varying sizes and shapes to accommodate all types of portable consumer electronics including mobile telephones, personal digital assistants (PDAs), camera, etc., all without departing from the scope or spirit of the invention.

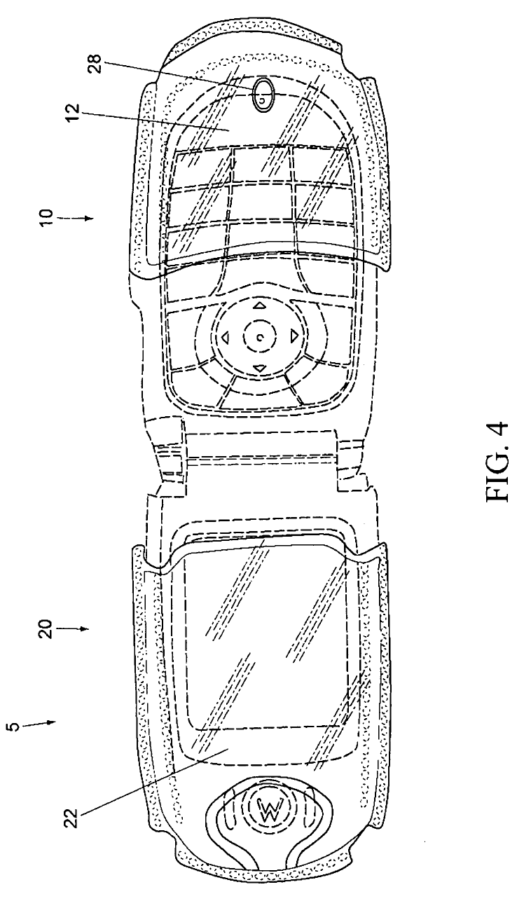

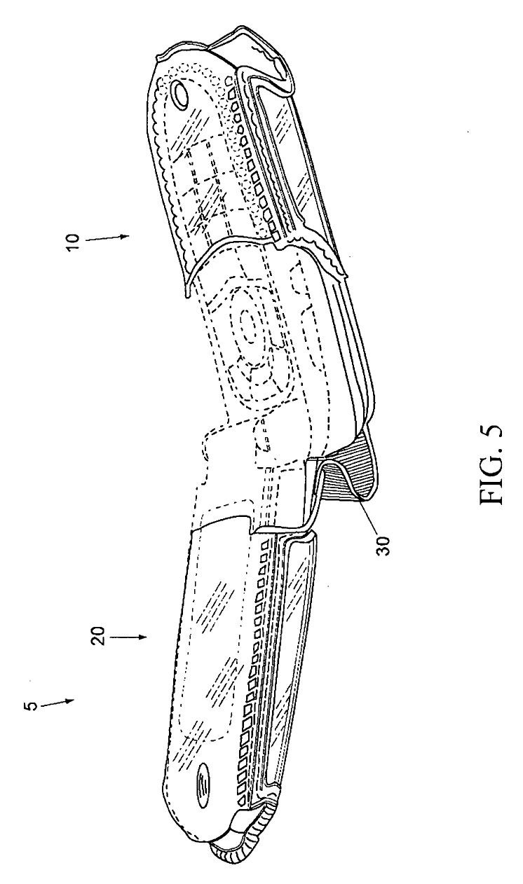

FIG. 1 is a rear perspective view of the gel-containing mobile telephone case in the open position, FIG. 4 is a front perspective view, and FIG. 5 is a left side perspective view with mobile phone shown in dotted lines, in the open position.

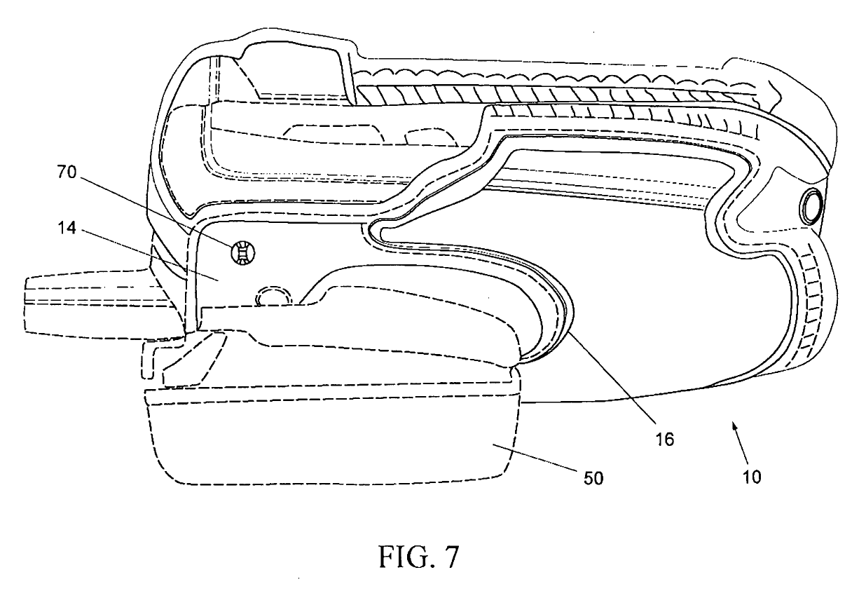

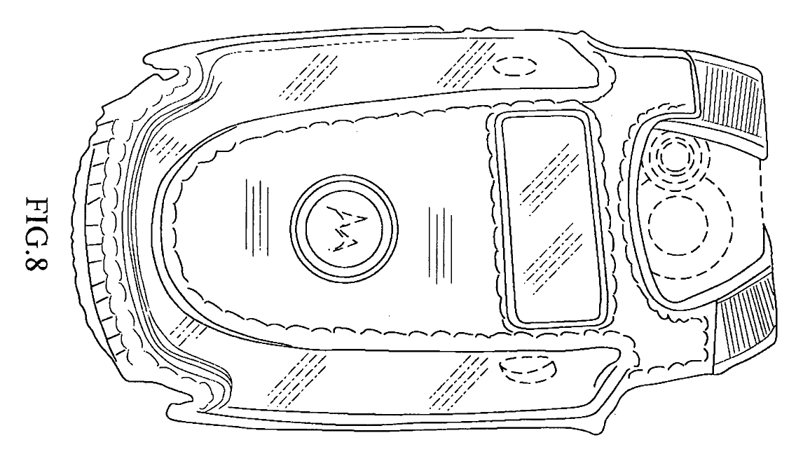

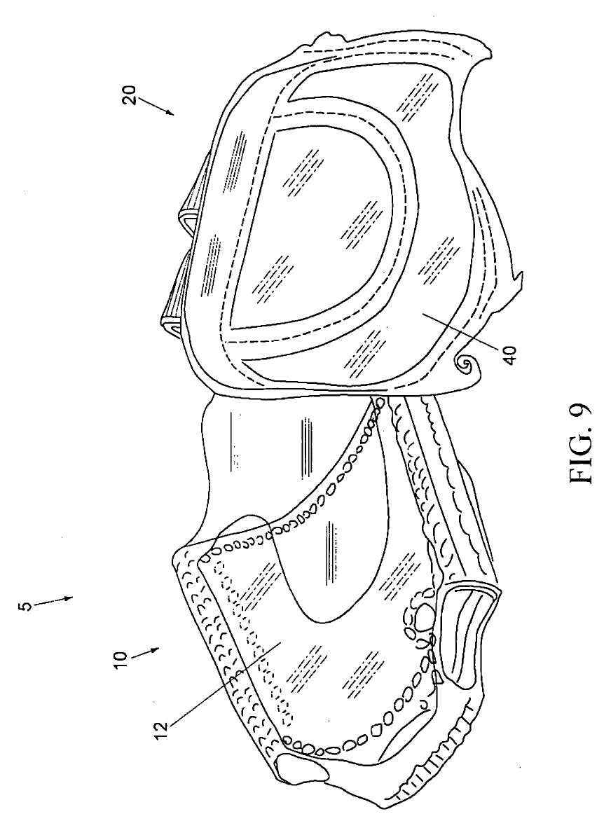

With combined reference to FIGS. 1, 4 and 5, the mobile phone case 5 generally comprises a first pocket section 10 and a second pocket section 20 joined together by dual-parallel straps 30. The first pocket section 10 is designed to receive one half of the flip phone, and the second pocket section 20 the other half. The dual-parallel straps 30 loop over the top of the flip phone, leaving space for the protruding antenna. Internal reservoirs in both the first pocket section 10 and second pocket section 20 are covered by clear flexible plastic and are filled with a cohesive gel 40 with optional suspended particulates to create a striking visual effect, such as a “snow-globe” and/or luminescent “glow-in-the-dark” effect. The gel 40 remains visible through the clear plastic reservoir in both the first and second pocket sections 10, 20, and provides a pleasing aesthetic as well as padding. If desired, the flange for a belt-clip 50 can be sewn in to allow the case 2 to be conveniently carried on one's belt (see FIG. 7).

The gel reservoirs surround a conventional belt clip in the second pocket section 20.

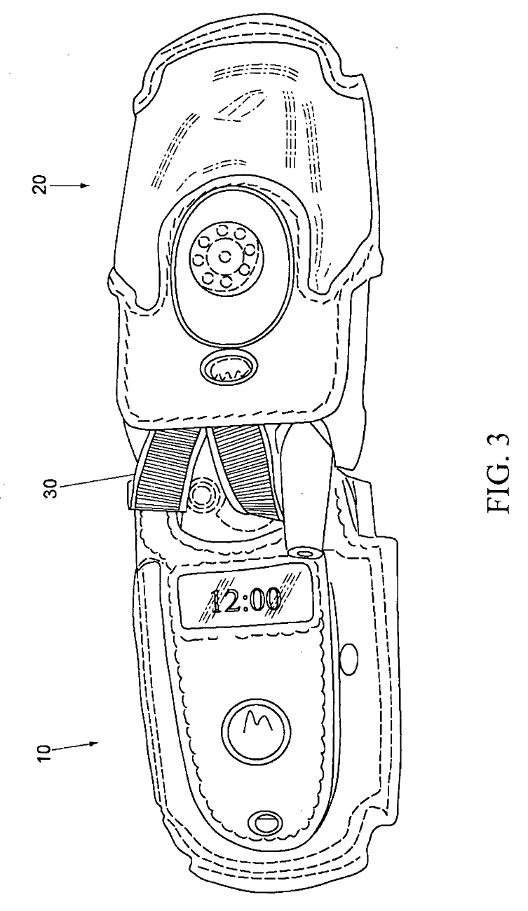

FIG. 3 is a rear perspective view of the gel-containing mobile telephone case, inclusive of the mobile flip-phone, in the open position. The first pocket section 10 is designed to receive one half of the flip phone, and the second pocket section 20 receives the other half of the flip phone (hinged to the first half), while dual-parallel elastic straps 30 are looped over the top of the phone to secure it in the pockets 10, 20.

Referring back to FIG. 5, both pocket sections 10, 20 are formed of pattern-cuts of two different materials joined together by a combination of stitching and heat welding. The first pocket section 10 is formed with an interior panel 12 for exposing the keyboard of the flip phone, and an exterior panel (obscured) for adorning and protecting the rear of the flip phone, the exterior panel being formed of a combination of trim material 16 such as leather, denim, cotton, etc, and the clear flexible plastic layer 14. The interior panel 12 is sewn peripherally to the exterior panel to form a pocket. The plastic layer 14 of the exterior panel is formed of two overlying sections of clear flexible plastic material that are heat welded around their periphery to form a gel reservoir. Cohesive gel (as will be described) is inserted into the area of the gel reservoir just prior to the heat welding. The trim section 16 is formed of decorative leather, denim, cotton, etc, and trim section 16 is sewn over the areas of the plastic layer 14 that have been heat-welded together, thereby leaving the gel in the transparent reservoirs exposed and viewable. One skilled in the art will understand that the plastic layer 14 of the exterior panel may be heat welded to form varying gel reservoir patterns, including multiple reservoirs, as a matter of design choice. The illustrated crescent-shaped gel reservoir is but one example. The trim section 16 covers the heat-welded areas that do not contain gel, improving the aesthetic of the present case 2. If desired, the flange for a belt-clip can be sewn between the overlying layers of trim 16 and plastic 14 to allow the case 2 to be conveniently carried on one's belt.

Similarly, the second pocket section 10 is formed with an interior panel 22 for exposing the LCD display of the flip phone, and an exterior panel for adorning and protecting the rear of the flip phone, the exterior panel being formed of a combination of trim material 26 such as leather, denim, cotton, etc, and clear flexible plastic layer 24. The interior panel 22 is sewn peripherally to the exterior panel to form a pocket. The plastic layer 24 of the exterior panel is formed of two overlying sections clear flexible plastic material that are heat welded around their periphery to form another gel reservoir. The gel is again inserted into the area of the gel reservoir prior to heat welding. The trim section 26 may be formed of leather, denim, cotton, etc, as a matter of design choice. Trim section 26 is sewn over the areas of the plastic layer 24 that have been heat-welded together, thereby leaving the gel in the transparent reservoirs exposed and viewable. Again, varying gel reservoir patterns may be formed, including multiple reservoirs, as a matter of design choice. The trim section 26 covers the heat-welded areas that do not contain gel, improving the aesthetic of the case 2.

Referring back to FIG. 1, cutouts may be formed such as at 28 for allowing access to on-off switches on the cell phone, or the like. If these cutouts 28 penetrate a reservoir the edges of the cutout 28 must be heat-sealed to preserve the integrity of the reservoir.

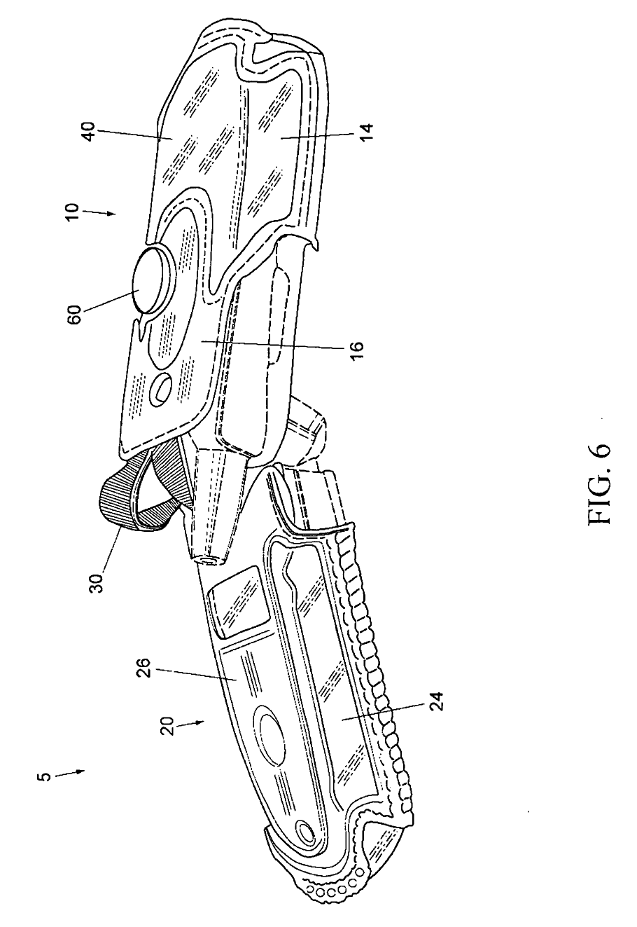

The two interior panels 12, 22 are also shown in FIG. 6, which is a side perspective view of the gel-containing mobile telephone case 2, with a mobile phone in the open position.

The internal reservoir(s) in both clear flexible plastic layers 14, 24 are filled with a cohesive gel 40, such as liquid silicone or silicone elastomers. The cohesive gel may be colorless, but is preferably colored, and even more preferably fluorescent to create a striking visual effect, and/or luminescent to create a “glow-in-the-dark” effect. The gel 40 remains visible through the clear plastic reservoir in both the first and second pocket sections 10, 20, and if colored, provides a pleasing aesthetic that is contrasted to the areas of trim 16, 26.

To insert gel 40 into the reservoirs, the gel 40 may be injected during or after the heat welding process, followed by resealing of the overlying plastic layers 14, 24 which form the reservoirs. It is important that all gel reservoirs be completely sealed to prevent leakage of the gel.

In addition to the above-described aesthetic appeal, the gel-containing reservoirs provide a superior cushion or insulation effect that helps to protect the enclosed mobile telephone from external force and damage.

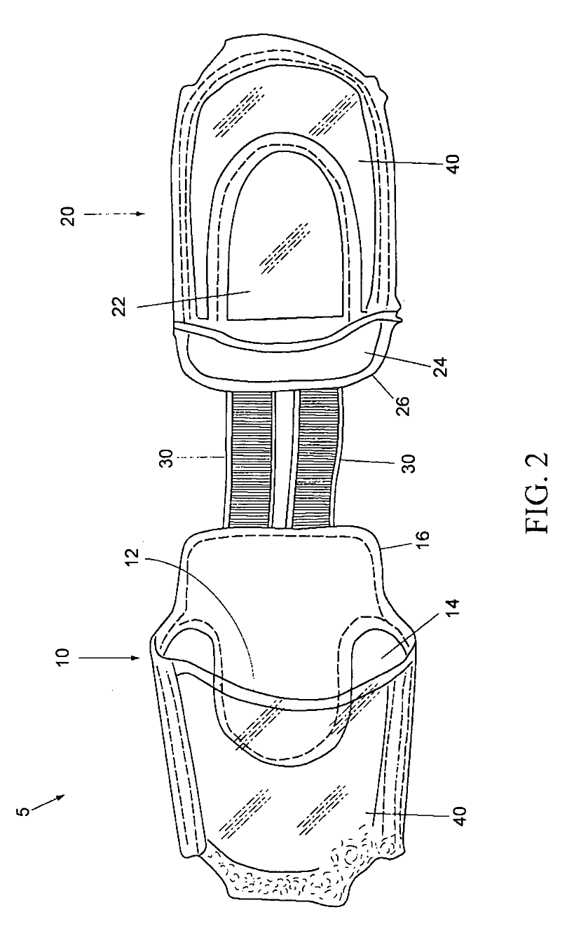

FIG. 2 is a front perspective view of the gel-containing mobile telephone case, exclusive of a mobile phone, in the open position. The exterior panel of first pocket section 10 includes trim material 16 and clear flexible plastic layer 14. The trim 16 is stitched to clear flexible plastic layer 14 as shown (the same s true for the trim 26 and plastic layer 24 of second pocket section 20).

The gel itself is a viscous liquid silicone or silicone elastomer, which may be colorless or colored, and preferably fluorescent and/or luminescent to create a “glow-in-the-dark” effect. Optionally, as shown in FIG. 7, any small discrete ornamental objects 50 may be inserted into the gel 40 prior to sealing the reservoir(s). These objects may be glitter, or miniature replicas of baseballs, footballs, soccer balls, automobiles, etc., or virtually any object that provides a distinct impression. By its nature, the viscous gel 40 provides a suspension medium in which the ornaments 50 are suspended in the gel, which allows them to float and move around within the gel. The constant movement of the gel creates endless variations of the views of the ornaments 40. FIG. 7 shows a number of exemplary ornament designs. In this manner, the cell phone case 2 of the present invention can be customized in accordance with each particular user's tastes to create unique design themes, which are particularly attractive to individuals with the respective hobbies and/or interests.

It should now be apparent that the decorative dimension of the gel-containing carrying case is uniquely aesthetic, and the design can readily be adapted for virtually any carrying cases for portable electronics including mobile telephones, personal digital assistants (PDAs) and other personal electronics. In all such instances the gel reservoirs and floating objects greatly enhance the decorative effect of the case while improving and maintaining its utility as a protective covering for the electronic appliance.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A carrying case for a portable electronic device comprising a pocket adapted to receive said portable electronic device, said pocket further comprising a first section of material and a second section of material seamed together to form said pocket, a section of clear flexible plastic heat-sealed externally to one of said first section of material and second section of material to form a fluid-tight reservoir, and a viscous gel inside said reservoir;
whereby said reservoir of cohesive gel creates a protective cushion and an aesthetic visual effect.

2. The gel-containing mobile telephone case according to claim 1 wherein said section of clear flexible plastic comprises any one from among a group consisting of plastic or acrylic

3. The gel-containing mobile telephone case according to claim 1, further comprising a plurality of discrete ornamental objects suspended in the gel inside said reservoir.

4. The gel-containing mobile telephone case according to claim 1, wherein said cohesive gel is colorless.

5. The gel-containing mobile telephone case according to claim 1, wherein said cohesive gel is colored.

6. The gel-containing mobile telephone case according to claim 1, wherein said cohesive gel is fluorescent.

7. The gel-containing mobile telephone case according to claim 1, wherein said cohesive gel comprises one of liquid silicone or silicone elastomer.

8. The gel-containing mobile telephone case according to claim 1, wherein said section of clear flexible plastic is joined externally to said first section of material by a combination of stitching and heat welding.

9. The gel-containing mobile telephone case according to claim 1, wherein said airtight sealed reservoir is formed by two overlying sections of clear plastic flexible material that are heat welded around their periphery.

10. The gel-containing mobile telephone case according to claim 1, wherein said first section comprises any one from among a group consisting of decorative leather, denim or cotton.

11. A gel-containing mobile telephone case, comprising:
a first section made of flexible material;
a second section made of clear flexible material;
dual parallel straps of flexible durable material;
an airtight sealed reservoir within said second section, for housing cohesive gel and solid materials,
whereby said reservoir of cohesive gel creates a protective cushion and an aesthetic visual effect.

12. The gel-containing mobile telephone case according to claim 11, further comprising a plurality of discrete ornamental objects suspended in the gel inside said reservoir.

13. The gel-containing mobile telephone case according to claim 11, wherein said cohesive gel is colorless.

14. The gel-containing mobile telephone case according to claim 11, wherein said cohesive gel is colored.

15. The gel-containing mobile telephone case according to claim 11, wherein said cohesive gel is fluorescent.

16. The gel-containing mobile telephone case according to claim 11, wherein said cohesive gel comprises one of liquid silicone or silicone elastomer.

17. The gel-containing mobile telephone case according to claim 11, wherein said section of clear flexible plastic is joined externally to said first section of material by a combination of stitching and heat welding.

18. The gel-containing mobile telephone case according to claim 11, wherein said airtight sealed reservoir is formed by two overlying sections of clear plastic flexible material that are heat welded around their periphery.

19. The gel-containing mobile telephone case according to claim 11, wherein said first section comprises any one from among a group consisting of decorative leather, denim or cotton.
